(19) United States
(12) Patent Application Publication
(10) Pub. No.: US 2009/0058892 A1
(43) Pub. Date: Mar. 5, 2009

(54) Direct thermal and inkjet dual-sided printing

(75) Inventor: Michael J. VanDemark, Springboro, OH (US)

Correspondence Address: CHARLES MANEY;NCR CORPORATION, LAW DEPT., 1700 S. PATTERSON BLVD., DAYTON, OH, 45479-0001, US

(73) Assignee: NCR Corporation

(21) Appl. No.: 11/897,659

(22) Filed: Aug. 31, 2007

(51) Int. Cl. B41J 3/00

(52) U.S. Cl. 347/2

(57) ABSTRACT

A dual-sided printer comprises: a first direct thermal print head positioned proximate to a first inkjet print head, the first direct thermal print head and the first inkjet print head being adapted to print a first side of a thermal-inkjet media; and a second direct thermal print head positioned proximate to a second inkjet print head, the second direct thermal print head and the second inkjet print head being adapted to print a second side of the thermal-inkjet print media. The thermal-inkjet print media comprises: a substrate including a first side and a second side; a first direct thermal coating and a first inkjet receptive coating on the first side of the substrate; and a second direct thermal coating and a second inkjet receptive coating on the second side of the substrate. Also provided is a method of printing the thermal-inkjet print media via the dual-sided printer.

### TECHNICAL FIELD

This disclosure relates to dual-sided printing. More particularly, this disclosure includes example embodiments directed to a direct thermal and inkjet dual-sided printer, dual-sided thermal/inkjet print media therefor and a method for printing the dual-sided thermal/inkjet media.

### BACKGROUND

In many industries and applications there has been a shift away from printing documents including transaction documents (e.g., receipts, tickets, gift certificates, sweepstakes and the like) using bond paper, toward printing such documents using thermal paper or media in direct thermal printers. In direct thermal printing, a thermal print head selectively applies heat to thermal paper or other sheet media, which includes a substrate with one or more thermally sensitive coatings that change color when heat is applied, thereby providing “printing” on the coated substrate.

Direct thermal printing includes single-sided direct thermal printing for thermal printing of one side of the thermal media, and dual-sided direct thermal printing for thermal printing of both sides of the thermal media. In dual-sided direct thermal printing, a thermal printer is configured to allow concurrent printing on both sides of thermal media moving along a feed path through the thermal printer as further described in U.S. Pat. Nos. 6,784,906 and 6,759,366. In such a dual-sided direct thermal printer, a thermal print head is disposed on each side of two-sided thermal media comprising, inter alia, a substrate with a thermally sensitive coating on each of two opposing surfaces thereof. Each thermal print head faces an opposing platen across the thermal media from the respective print head. During printing, the opposing thermal print heads selectively apply heat to opposing sides of the two-sided thermal media, such that printing is provided on both sides thereof.

Single or dual-sided direct thermal printing is typically provided in one color (e.g., black, blue or red) on one or both imageable sides of respective single or dual-sided direct thermal media. For dual-sided direct thermal printing, a different color (e.g., black, red or blue) may be provided on each of two opposite imageable sides. However, printing of one or both sides of a document in one color (e.g., black, blue or red), such as for printing of transaction detail, and simultaneously printing the other side or both sides of the document in full color (e.g., CMYK), such as for printing of an advertisement, a coupon, highlighting important information thermal imaged, which may be advantageous for point-of-sale applications, among others, is not readily available. Although single-sided direct thermal color printing has been developed and dual-sided direct thermal color printing is under development, they remain prohibitively expensive for many applications, especially in printing transaction documents containing multi-color images such as advertising at the point of sale. However, color inkjet printing is less expensive and has been employed in a variety of single-sided full color applications, such as desktop printing, for some time.

### SUMMARY

In accordance with an embodiment, there is provided a dual-sided printer comprising: a first direct thermal print head positioned proximate to a first inkjet print head, the first direct thermal print head and the first inkjet print head being adapted to print a first side of a thermal-inkjet media; and a second direct thermal print head positioned proximate to a second inkjet print head, the second direct thermal print head and the second inkjet print head being adapted to print a second side of the thermal-inkjet media.

In accordance with another embodiment there is provided a thermal-inkjet print media comprising: a substrate including a first side and a second side; a first direct thermal coating and a first inkjet receptive coating on the first side of the substrate; and a second direct thermal coating and a second inkjet receptive coating on the second side of the substrate.

In accordance with a further embodiment, there is provided a method of imaging a print a thermal-inkjet print media including a first side and a second side opposite the first side, the method comprising: receiving printing data; delineating the received printing data into at least a first portion, a second, a third portion and a fourth portion; activating a first direct thermal print head to image the first portion of the delineated printing data on the first side of the print media; activating a second direct thermal print head to image the first portion of the delineated printing data on the second side of the print media; activating a first inkjet print head to print the third portion of the delineated printing data on the first side of the print media; and activating a second inkjet print head to print the third portion of the delineated printing data on the second side of the print media.

### BRIEF DESCRIPTION OF THE DRAWINGS

Various features and attendant advantages of the example embodiments will be more fully appreciated as the same becomes better understood when considered in conjunction with the accompanying drawings, in which like reference characters designate the same or similar parts throughout the several views, and wherein:

FIG. 1 illustrates a schematic of an example direct thermal and inkjet dual-sided printer for dual-sided direct thermal and inkjet printing;

FIG. 2 illustrates a cross-section of an example combination direct thermal and inkjet print media for use in a printer in accordance with FIG. 1; and

FIGS. 3A-3B illustrate an example first side and an example second side of a printed transaction document imaged using the example printer and media in accordance with FIGS. 1 and 2.

### DETAILED DESCRIPTION

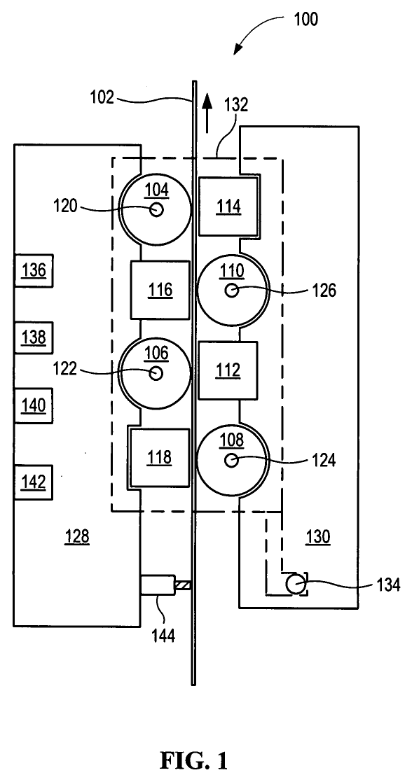

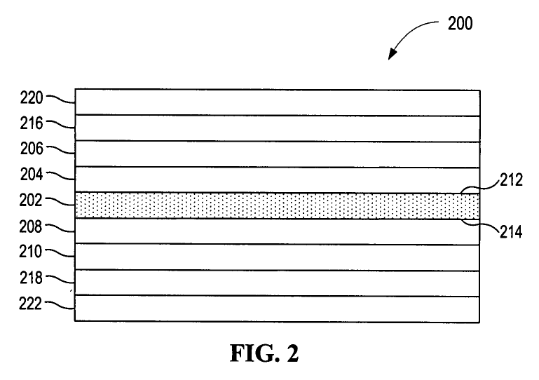

FIG. 1 illustrates a schematic of an example direct thermal and inkjet dual-sided printer 100 for dual-sided printing of print media 102 such as that described below with reference to FIG. 2. A variety of print media 102 may be used to print various documents, such as receipts, tickets, gift certificates, sweepstakes, coupons, vouchers, as well as many other documents not enumerated herein. As will be described in greater detail below with reference to FIG. 2, print media 102 is a combination dual-sided thermal/inkjet media, including a thermally sensitive coating an inkjet receptive coating, and possibly, one or more base and/or top coat layers, on both sides thereof to facilitate thermal and inkjet printing via the dual-sided printer 100. The dual-sided thermal printing may be in a single color (e.g., black, blue or red), while the dual-sided inkjet printing may be in any variety of colors including full or process color printing (e.g., cyan, magenta, yellow and black: CMYK).

Further with reference to FIG. 1, the dual-sided printer 100 may include first and second support arms 128 and 130. Second support arm 130 may be journaled on an arm shaft 134 to permit the second support arm 120 to pivot or rotate in relation to the first support arm 128 to, for example, facilitate access to, and servicing of, the dual-sided printer 100. The support arms 128 and 130 may also be in a fixed relation to one another. The dual-sided printer 100 may further include platens 104 and 106 and opposing print heads 112 and 114 on opposite sides of the print media 102. Still further, the dual-sided printer 100 may further include platens 108 and 110 and opposing print heads 116 and 118 on opposite sides of the print media 102. More specifically, the first support arm 128 may include a first and second platens 104, 106, a first thermal print head 116 and a first inkjet print head 118, while the second support arm 130 may include a third and fourth platens 108, 110, a second thermal print head 112 and a second inkjet print head 114. Alternatively, either the first or second support arms 118 or 120 may include the first, second, third and fourth platens 104, 106, 108, 110, the first and second thermal print heads 116, 112, and the first and second inkjet print heads 118, 114.

In further reference to FIG. 1, additional thermal and/or inkjet print heads may be provided on opposite sides of the print media 102. More specifically, multiple thermal print heads may each be used to print a single color (e.g., black, blue and red), while multiple inkjet print heads may each be used for a different color (e.g., CMYK) in a full or process color application.

As illustrated in FIG. 1, the platens 104, 106, 108, 110 are substantially cylindrical in shape, although other shapes, including flat surfaces such as plates, are possible. The first and second platens 104, 106 may be journaled on first and second shafts 120, 122, while the third and fourth platens 108, 110 may be journaled on third and fourth shafts shaft 124, 126. The shafts 120, 122, and shafts 124, 126, maybe coupled to the support arms 128 and 130, respectively. Alternatively, shafts 120, 122, 124, 126 may be coupled to a single support arm such as support arm 128 or 130.

With further reference to FIG. 1, it is noted that the print heads 116, 118, 112 and 114 are substantially in-line and face substantially opposed directions. As a result, the media feed path of the print media 102 may be substantially a straight line path given the substantially in-line orientation of the print heads 116, 118, 112 and 114. This configuration facilitates in-line feeding and exiting of the print media 102 to and from the dual-sided printer 100. The in-line feed path also facilitates automation of print media 102 replacement and feed, allowing the print media 102 to be automatically drawn from print head 118 and platen 108, to print head 112 and platen 106, to print head 116 and platen 110, through to print head 114 and platen 104, or vice-versa, and accommodates thick or stiff thermal/inkjet media which may resist being bent or it may be otherwise undesirable to bend. Although the in-line orientation of print heads 116, 118, 112, 114 is described, alternate orientations between print heads, including varied angle orientations (e.g., 45, 90, 135 and 180 degrees), are possible based on particular design requirements of the dual-sided printer 100, the print media 102 and/or the desired media feed path.

Still further with reference to FIG. 1, a dual-sided printer 100 may include a drive assembly 132. Drive assembly 132 may comprise one or more motors (not shown) for powering a system of gears, links, cams, and combinations thereof for operating the dual-sided printer 100. More specifically, platens 104, 106, 108, 110 are rotatable via drive assembly 132 about shafts 120, 122, 124 and 126, respectively, for moving the print media 102 through the dual-sided printer 100. Additionally, first and second thermal print heads 116, 112 and first and second inkjet print heads 118, 114 may be stationary or fixed in the dual-sided printer 100 in relation to the print media 102 as it is advanced by the drive assembly 122 for printing. More specifically, the print heads 112, 114, 116, and 118 may be sufficiently wide (e.g., about as wide or wider than width of print media 102) to print the print media 102. Alternatively, one or more of the thermal print heads 116, 112 and inkjet print head 118, 114 may be narrower than the width of the print media 102 and may be stationary, or moveable laterally, e.g., perpendicularly to the movement of print media 102, via a lateral motion assembly (not shown) that may also be powered by the drive assembly 122 to print across the width of the print media 102. The direct thermal print heads 116, 112 may be include any print heads suitable for direct thermal imagining of print media 102, such as those disclosed in U.S. Pat. Nos. 3,947,854, 4,708,500 and 5,964,541. The inkjet print heads 118, 114 may be any print heads suitable for inkjet printing print media 102, and may include one or more nozzles for depositing a single color or a plural colors on print media 102.

Additionally with reference to FIG. 1, the dual-sided printer 100 may further include one or more sensors 144 for determining various conditions to control operation of the printer 100, such as a media sensor to detect a paper low and/or a paper in/out condition, a media type sensor to detect a type of media (e.g., non-thermal, single-sided thermal, double-sided thermal, inkjet receptive, high and low gloss, and the like) installed in the printer 100, and a media size sensor to detect a size of media (e.g., width, length, thickness, shape, etc.) installed in the printer 100. Sensing of media type is described in U.S. patent application Ser. No. 11/644,262, which is hereby incorporated in its entirety by reference herein.

Yet further with reference to FIG. 1, the dual-sided printer 100 operates on print media 102, which may be supplied in the form of a continuous paper roll, a continuous fan-folded stack or cut sheet stock, and upon which features such as graphics or text, and combinations thereof, may be printed on one or both sides thereof via the respective print heads 112, 114, 116 and 118, to provide a printed document having one or both sides imaged via direct thermal printing in one color, and another or both sides printed via inkjet printing in one or multiple colors via full or process color printing (e.g., cyan, magenta, yellow and black: CMYK). Although a variety of documents may be printed, documents such as receipts, tickets and coupons may be particularly well suited, in which transaction detail in one color may be imaged on one or both sides by the direct thermal printed heads 116, 112 and important information printed by the thermal print heads may be highlighted in color by the inkjet print heads 118, 114. Furthermore, the inkjet print heads 118, 114 may further be used to print advertising or other subject matter that can benefit from use of color using a variety of colors, including full color, on the one or both sides. In some applications, such as tickets, it may be desirable to include transaction information (e.g., date, time, price, purchaser, payment means, origin, destination, event, and the like) on one or both sides of print media 102 in one color via thermal print heads 116, 112 and to highlight important parts of the imaged information, such as price, return policy and the like, in one or multiple colors via inkjet print heads 118, 114. In other applications, advertisements on one or both sides of the print media 102 may be printed via inkjet print heads 118, 114 in a single or full color to draw purchaser's attention. Still in other applications, it may also be desirable to provide a full color picture of a purchaser and/or designated attendee via inkjet print heads 118, 114 on one or both sides of the print media 102. Where applied to receipts, such applications may be used to improve readability of transaction detail and improve purchaser's interest in advertisement, minimize the risk of receipt fraud by tying the purchase of one or more items, and subsequent return thereof, to a particular person.

Further with reference to FIG. 1, dual-sided printing may be facilitated by, for example, the print media 102 including a thermal coating comprising a thermal imaging component and an inkjet receptive coating on both sides of the print media 102. The print media 102 may also include a sufficiently thermally resistant substrate to inhibit thermal printing on the one side of the print media 102 from affecting thermal printing and inkjet printing on the opposite side of the print media 102. The substrate may also be sufficiently ink resistant (e.g., hydrophobic, non-porous, and the like) to inhibit inkjet printing on the one side of the print media 102 from affecting thermal or inkjet printing on the opposite side of the print media 102. The substrate may be a cellulosic or a polymer substrate sheet coated on each side with a thermal coating having a heat sensitive dye an inkjet receptive coating. The inkjet receptive coating is thermally conductive to allow heat from the thermal print heads 116, 112 to penetrate to the thermal coating to image the thermal coating and also translucent to allow imaged details to be seen.

With further reference to FIG. 1, the dual-sided printing of the print media 102 may be accomplished in a single pass process. Alternately, the dual-sided printing may be accomplished in a process where the media 102 may be printed by one or more of the print heads 112, 114, 116 and 118 when moving in a first direction, and then retracted for further printing by one or more of the print heads 112, 114, 116 and 118 with the print media 102 moving in either the first or the second, retract direction. Once printing is completed, the print media 102 may be manually or automatically cut or detached via a cutoff device (not shown), where the print media 102 exits from the dual-sided printer 100, to form a document having, inter alia, single color thermal printing on one or both sides and single or full color inkjet printing on the other or both side thereof.

Still with further reference to FIG. 1, the dual-printer 100 also includes control electronics for controlling the operation of the dual-sided printer 100. The control electronics may include a microprocessor or central processing unit (CPU) 136, and memory 138, such as one or more dynamic random access memory (DRAM) and/or non-volatile random access memory (NVRAM) print buffer memory elements. The control electronics may further include a communication controller 140 for communicating with one or more host or auxiliary systems, such as a point-of sale (POS) terminal or a computer, for input of data to and output of data from the dual-sided printer 100. The communication controller 140 may support universal serial bus (USB), Ethernet and/or wireless communications, among others. The data for printing would typically be supplied by the POS terminal or the computer communicating with the dual-sided printer 100 via the communication controller 140.

As further illustrated in FIG. 1, the printer 100 may further include a printing function switch 142, implemented in hardware or software, for controlling, inter alia, operation of one or more dual-sided printer modes or functions including operation of a first and second thermal print head 116, 112 and first and second inkjet print heads 118, 114. Dual-sided printer functionality may be controlled using commands implemented with, for example, setup configuration settings in hardware or software, escape sequences, real-time printer commands, and the like. The printing function switch 142 may buffer received printing data in memory 138 and may further determine how the received or buffered printing data is to be delineated between a first and a second side of print media 102. For example, the printing function switch 132 may automatically designate received transaction detail to be imaged in a single color via thermal print heads 116, 112 on a first side and/or second side of the print media 102, important information of the first and/or second side to be highlighted in one or full color via inkjet print heads 118, 114, while designating received advertisement detail for printing in one or more colors, up to and including full color, via inkjet print head 118, 114 on the first and/or the second side of the print media 102.

In one embodiment, the printing function switch 142 may designate received transaction detail for printing on a first side and/or the second side of the media 102 by storing the received transaction detail in a first portion and/or second portion of the memory 138, respectively. Likewise, the printing function switch 142 may designate received advertisement detail and highlighting of portions of received transaction detail for printing in one or more colors, up to and including full color, on the first and/or the second side of the media 102 by storing the received advertisement detail and highlighting detail in a third portion and/or fourth portion of memory 138, respectively. Data retrieved from the first and third memory portions may then be printed on the first side of the print media 102 while data retrieved from the second and fourth memory portion may be printed on the second side of the media 102. Such data may be retrieved and/or further processed for printing by the CPU 126.

In operation, advertisement detail and highlighting detail data may be received contemporaneously with transaction detail data from a host terminal or computer such as a POS terminal. Alternatively, advertisement detail comprising one or more advertisements, coupons, vouchers, rebates and the like, as well as and highlighting detail comprising designated fields or portions of the foregoing to highlight may be received and stored in advance of the transaction detail, and selected for printing with particular transaction detail by the printing function switch 142. Such selection may be made based on, inter alia, the transaction detail including goods or services purchased, a time of day, a day of the week, a week, month, or season of the year of the transaction, a total transaction price, payment means (e.g., credit, debit, check, automatic funds transfer, etc.), identity of the purchaser, purchase history, a loyalty program, and the like. Alternately, such selection may be random according to one or more algorithms.

In one embodiment, with reference to FIG. 1, memory 138 of the dual-sided printer 100 may have a predefined print data storage area to store one or more blocks of predefined print data to be repetitively printed on one or both sides of the print media 102. The blocks of predefined print data may include, for example, one or more of a store or other location identifier, a logo, an advertisement, coupon information, legal information including warranties and disclaimers, and the like. Additional information not expressly enumerated may also be included in the blocks of predefined print data. The predefined print data may be printed along with received printing data provided by the POS terminal or computer on any one or both sides of print media 102. Such printing may be automatic, occurring every time without other intervention or control, and/or may be selectable and/or controllable by, for example, the printing function switch 142. Where multiple data blocks are stored in the predefined print data storage area, or received from the POS terminal via the communication controller 140, the blocks may be alternately selected for printing on one or both sides of the print media 102 by the printing function switch 142. In addition to being selected for printing as part of each print job, such predefined print data may be selected for printing based on, for example, received transaction detail or a random algorithm as described above.

In addition to the use of a printing function switch 142, the dual-sided printer 100 may support different mechanisms for delineating received print data for printing on the print media 102. For example, the CPU 126 may receive delineated data for printing by respective print heads 112, 114, 116 and 118 directly from the communication controller 140, and the CPU 126 may then control activation of the respective print heads 112, 114, 116 and 118 for printing the received print data on the respective sides of print media 102.

FIG. 2 illustrates a cross-section 200 of an example combination direct thermal and inkjet print media 102 for use in printer 100 in accordance with FIG. 1. As depicted in cross-section 200, the print media 102 may include a substrate 202 having a first surface 212 and a second surface 214. The first surface 212 may further be coated with a first primer 204, a first thermal functional coating 206, a first inkjet receptive coating 216 and a first top coat 220. The second surface 214 may further be coated with a second primer 208, a second thermal functional coating 210, a second inkjet receptive coating 218, and second top coating 222. The first and second thermal functional coatings 206, 210 may include one or more leuco dyes, developers and/or sensitizers. The first and second inkjet receptive coatings 216, 218 may have one or more layers of ceramic particles arranged into a pattern of pores. The substrate 202 may be generally opaque to inhibit direct thermal printing on one side of the print media 102 from being visible on the other side of the print media 102, as well as inhibiting inkjet color printing on one side of the print media 102 from being visible on the other side of the print media 102. The substrate 202 may further be sufficiently thermally resistant to inhibit thermal printing on the one side of the print media 102 from affecting thermal or inkjet printing on the opposite side of the print media 102. Still further, the substrate 202 may also be sufficiently ink resistant to inhibit inkjet printing on the one side of the print media 102 from affecting thermal or inkjet printing on the opposite side of the print media 102.

Further with reference to FIG. 2, the first and second primers 204, 208 may applied to the first and second surfaces 212, 214, respectively, using any suitable process such as flooding and metering, followed by drying. Generally, flooding with an aqueous coating mixture and then metering off the excess accomplish the application of the first and second primers 204 and 208 to the substrate 202. The first and second thermal functional coatings 206, 210 may be applied, respectively, to the substrate 202 or the first and second primers 204 and 208 using any suitable process such as flooding and metering, followed by drying. Alternatively, spraying, dipping or gravure coating may be used instead of flooding and metering, with respect to applying the first and second primers 204 and 208, as well the first and second thermal functional coatings 206, 210 and the first and second inkjet receptive coatings 216, 218. Top first and second coatings 220, 222, as well as additional coatings (not shown), may also be applied to the respective first and second inkjet receptive coatings 216, 218 using any suitable process such as flooding and metering, followed by drying, or alternatively by spraying, dipping or gravure coating. The top and/or additional coatings may provide benefits in terms of image quality, permanence, and resistance to a wide range of detrimental or deleterious effects (e.g., scratching, water, ultraviolet light and the like), desired by various printing applications. It is noted that the first and second primers 204, 208, and the first and second top coatings 220, 222, may be omitted, with the print media 102 including just the first and second thermal functional coatings 206, 210 and the first and second inkjet receptive coatings 216.

Yet further with reference to FIG. 2, the substrate 202 may include a cellulosic material. Suitable cellulosic materials include non-woven pulp-based materials. Alternatively, the substrate 202 may include a polymeric material, such as polypropylene or polyethylene, which may be in the form of a film. The first and second primers 204 and 208 may be of any suitable material to facilitate the adherence of the thermal functional coatings 206, 210 to, respectively, the first and second surfaces 212 and 214 of the substrate 202. For example, the first and second primers 204 and 208 may be of a water-based mixture including mainly clay materials, which may be spread on the substrate 202 and then dried. The first and second primers 204, 208 may be used to buffer the first and second thermal functional coatings 206, 210 from active residue in the substrate 202.

Still further with reference to FIG. 2, the first and second thermal functional coatings 206, 210 may include any single color thermal imaging component for imaging a thermal side of print media 102 in a single color, as described above in reference to FIG. 1. The thermal imaging component may be a heat sensitive dye or dye precursor. In addition, the thermal imaging component may be mixed with appropriate binders, additives, solvents and reagents (e.g., activators) as desired to allow ease of coating when the first and the second thermal functional coatings 206, 210 are applied to the substrate 202 and proper functioning of the first and second thermal functional coatings 206, 210 when imaged by dual-sided printer 100. Furthermore, the first and second inkjet receptive coatings 216, 218 may include one or more coats for printing in full color, as described above in reference to FIG. 1. In addition, the first and second inkjet coatings 216, 218 may also provide advantages such as improved ink drying capabilities, as well as improved image stability.

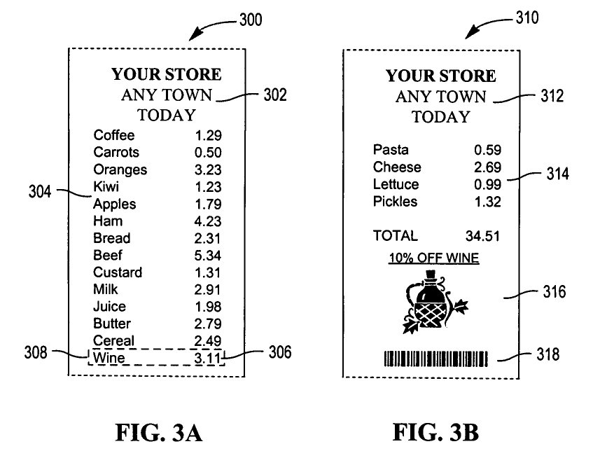

FIGS. 3A-3B illustrate an example first side 300 and an example second side 310 of a printed transaction document imaged using the example printer 100 and media 200 in accordance with FIGS. 1 and 2. As described hereinabove, the transaction document may be a receipt (as shown in FIGS. 3A-3B), a ticket, a gift certificate, a sweepstake, and the like. The first and second sides 300, 310 of the transaction document may include store-related details 302, 312, including store name, location, date of purchase, and the like. These details 302, 312 may be conveniently printed in one or more colors by respective inkjet print heads 114, 118. Transaction details 304, 314 may be imaged by respective direct thermal print heads 112, 116. One or more imaged transaction detail entries 306 on the first and/or second sides 300, 310 may also be highlighted 308 in one or more colors by respective inkjet print heads 114, 118. The transaction document may further include on the first and/or second sides 300, 310 one or more discounts, advertisements, coupons, and the like 316 printed in color by the respective inkjet print heads 114, 118, or imaged by respective direct thermal print heads 112, 116 and highlighted in one or more colors by respective inkjet print heads 114, 118. The transaction document may also include the a barcode 318 associated with the transaction imaged on the first and/or second sides 300, 310 by respective direct thermal print heads 112, 116. Additional information may be printed/imaged by the respective inkjet print heads 114, 118, the direct thermal print heads 112, 116, or a combination of both inkjet and thermal print heads, as may be desired for particular transaction documents.

In operation of the dual-sided printer 100, and in accordance with FIGS. 1-3, dual-sided print media 102 may be unrolled from a print media roll, taken from a fan-folded print media stack, or obtained as cut sheet stock from a paper tray, and may be moved along a media feed path through print heads 112, 114, 116, 118 for dual-sided inkjet/thermal printing (e.g., an example of which is illustrated in FIG. 3), after which it may be outputted to the outside of the dual-sided printer 100.

Further with reference to printer operation, the printer 100 may receive, via communication controller 140, delineated printing data (including color information for first and second inkjet print heads 118, 114) for printing by the respective print heads 112, 114, 116 and 118. Such print data may be stored in a memory 138 of the printer or directly sent to the CPU 136 for processing and printing by the respective print heads 112, 114, 116 and 118 on respective sides of print media 102 in accordance with FIGS. 1-2. Alternately, in some embodiments, operation of the printer 100, including selection of data for, and/or enabling of printing by, one or more of the print heads 112, 114, 116 and 118, may be controlled by a printing function switch 142 as further described hereinabove. Such control may comprise delineating received and/or stored data for printing by respective print heads 112, 114, 116 and 118.

Additionally, in some embodiments, printer control may be provided based on one or more signals from one or more print sensors 144. Such print sensors 144 may include (i) a paper quantity sensor for producing a signal indicative of a quantity of paper (e.g., full, low and/or out) installed in or associated with a printer 100, (ii) a print media type sensor for producing a signal indicative of a type of media (e.g., non-thermal, single-sided thermal, double-sided thermal, inkjet receptive, inkjet receptive thermal, and the like) installed in or associated with a printer 100, and/or (iii) a print media size sensor for producing a signal indicative of a size (e.g., length, width and/or thickness) of media installed in or associated with the printer 100. One or more signals from the one or more installed print sensors 144 may be used to control one or more functions or operations of the printer 100 such as enabling and/or disabling printing by one or more print heads 112, 114, 116 and 118, a location for printing on one or both sides of the media 102 by one or more print heads 112, 114, 116 and 118, a speed of printing, a quantity of ink dispersed by first and second inkjet print heads 118, 114, a quantity of heat applied by one or more thermal print heads 116, 112, and the like.

The above description is illustrative, and not restrictive. Many other embodiments will be apparent to those of skill in the art upon reviewing the above description. The scope of embodiments should therefore be determined with reference to the appended claims, along with the full scope of equivalents to which such claims are entitled.

The Abstract is provided to comply with 37 C.F.R. § 1.72(b) and will allow the reader to quickly ascertain the nature and gist of the technical disclosure. It is submitted with the understanding that it will not be used to interpret or limit the scope or meaning of the claims.

In the foregoing description of the embodiments, various features are grouped together in a single embodiment for the purpose of streamlining the description. This method of disclosure is not to be interpreted as reflecting that the claimed embodiments have more features than are expressly recited in each claim. Rather, as the following claims reflect, inventive subject matter lies in less than all features of a single disclosed embodiment. Thus the following claims are hereby incorporated into the Detailed Description, with each claim standing on its own as a seperate example embodiment.

What is claimed is:

1. A dual-sided printer comprising:
a first direct thermal print head positioned proximate to a first inkjet print head, the first direct thermal print head and the first inkjet print head being adapted to print a first side of a thermal-inkjet media; and
a second direct thermal print head positioned proximate to a second inkjet print head, the second direct thermal print head and the second inkjet print head being adapted to print a second side of the thermal-inkjet media.

2. The dual-sided printer of claim 1, wherein the first direct thermal print and the second inkjet print head are at an angular orientation with respect to the first inkjet print head and second direct thermal print head.

3. The dual-sided printer of claim 2, wherein the angular orientation is selected from the group consisting of: 45 degrees; 90 degrees; 135 degrees; and 180 degrees.

4. The dual-sided printer of claim 1, wherein the first inkjet print head or the second inkjet print head is disposed in a fixed position.

5. The dual-sided printer of claim 1, wherein the first inkjet print head or the second inkjet print head is moveable.

6. The dual-sided printer of claim 1, wherein the first direct thermal print or the second thermal print head is adapted to image in a single color.

7. The dual-sided printer of claim 1, wherein the first inkjet print head or the second inkjet print head is adapted to print in a single or full color.

8. The dual-sided printer of claim 1, further comprising a controller adapted to:
receive printing data; and
delineate the printing data to be imaged by the first direct thermal print head and the second direct thermal print head, and to be printed by the first inkjet print head and the second inkjet print head.

9. The dual-sided printer of claim 8, further comprising a central processing unit adapted to:
receive the delineated the printing data; and
activate the first direct thermal print head or the second direct thermal print head and the first inkjet print head or the second inkjet print head to print respective portions of the delineated printing data.

10. The dual-sided printer of claim 8, further comprising a central processing unit adapted to:
receive the delineated the printing data; and
activate the first direct thermal print or the first inkjet print head to image a first portion of the delineated printing data on the first side of the print media, and
activate the second direct thermal print inkjet print head or the second inkjet print head to print a second portion of the delineated printing data on the second side of the print media.

11. A thermal-inkjet print media comprising:
a substrate including a first side and a second side;
a first direct thermal coating and a first inkjet receptive coating on the first side of the substrate; and
a second direct thermal coating and a second inkjet receptive coating on the second side of the substrate.

12. The thermal-inkjet print media of claim 11, further comprising:
a first primer disposed between the substrate and the first direct thermal coating on the first side; and
a second primer disposed between substrate and the second direct thermal coating on the second side.

13. The thermal-inkjet print media of claim 11, further comprising a first top coating disposed over the first inkjet receptive coating and a second top coating disposed over the second inkjet receptive coating.

14. The thermal-inkjet print media of claim 11, wherein the substrate is generally opaque to inhibit thermal imaging on the first side from being visible on the second side and inhibit thermal imaging on the second side from being visible on the first side, and to inhibit inkjet printing on the first side form being visible on the second side and inhibit inkjet printing on the second side from being visible on the first side.

15. The thermal-inkjet print media of claim 11, wherein the substrate is sufficiently thermally resistant to inhibit thermal imaging on the first side from affecting thermal or inkjet printing on the second side and to inhibit thermal imaging on the second side from affecting thermal or inkjet printing on the first side.

16. The thermal-inkjet print media of claim 11, wherein the substrate is sufficiently ink resistant to inhibit inkjet printing on the first side from affecting thermal imaging or inkjet printing on the second side and to inhibit inkjet printing on the second side from affecting thermal imaging or inkjet printing on the first side.

16. A method of imaging a print a thermal-inkjet print media including a first side and a second side opposite the first side, the method comprising:
receiving printing data;
delineating the received printing data into at least a first portion, a second, a third portion and a fourth portion;
activating a first direct thermal print head to image the first portion of the delineated printing data on the first side of the print media;
activating a second direct thermal print head to image the first portion of the delineated printing data on the second side of the print media;
activating a first inkjet print head to print the third portion of the delineated printing data on the first side of the print media; and
activating a second inkjet print head to print the third portion of the delineated printing data on the second side of the print media.

17. A method of claim 16, further comprising imaging the first portion of the delineated printing data on the first side of the print media in a first color.

18. A method of claim 16, further comprising imaging the second portion of the delineated printing data on the second side of the print media in a second color.

19. A method of claim 16, further comprising printing the third portion of the delineated printing data on the first side of the print media in a single color or multiple colors.

20. A method of claim 16, further comprising printing the fourth portion of the delineated printing data on the second side of the print media in a single color or multiple colors.

21. A method of claim 16, further comprising using the third portion of the delineated printing data to highlight the first portion of data imaged on the first side of the print media.

22. A method of claim 16, further comprising using the fourth portion of the delineated printing data to highlight the second portion of data imaged on the second side of the print media.
